(19) United States
(12) Patent Application Publication
(10) Pub. No.: US 2009/0092093 A1
(43) Pub. Date: Apr. 9, 2009

(54) Handoff of dual mode mobile device between an IP network and a PLMN

(75) Inventors: Wai Keung Wu, New Territories (HK); King Wai Chow, New Territories (HK)

Correspondence Address: WELLS ST. JOHN P.S., 601 W. FIRST AVENUE, SUITE 1300, SPOKANE, WA, 99201, US

(73) Assignee: Hong Kong Applied Science and Technology Research Institute Company Limited

(21) Appl. No.: 11/906,641

(22) Filed: Oct. 3, 2007

(51) Int. Cl. H04Q 7/00

(52) U.S. Cl. 370/331

(57) ABSTRACT

A device and a method for handoff of a VoIP internet telephone call from an IP network to a cellular network and for hand-back of the call to the IP network, in which during or after hand-off of the call an identifier of the hand-off call is obtained and stored and the identifier is used during hand-back of the call to the IP network.

### BACKGROUND OF THE INVENTION

1. Field of the Invention

The invention relates to handoff of a dual mode mobile device between an IP network and a public land mobile network (PLMN), commonly referred to as a cellular network. In particular, the invention relates to a device and a method for handoff of a VoIP internet telephone call from an IP network to a PLMN and for hand-back of the call to the IP network.

2. Background Information

Internet telephone service, such as that provided by Vonage, SIP phone and Skype, is revolutionizing telephone communications and is one of the fastest growing telecommunications applications at the current time. The attraction of such services is that voice communication can be had with any internet telephone, fixed line telephone or mobile telephone for little or no cost.

One problem that exists with internet telephone services is the service coverage area. In the early days internet telephone service was only available on an internet connected computer using a microphone and speakers. Cordless and wireless IP telephones have become available which allow users to make internet telephone calls from anywhere within the coverage area of cordless telephone base station or a wireless IP network. While this allows users much more freedom in wherein how they make internet telephone calls, they are still limited to being within the coverage area of the telephone base station or an IP network. Although many organizations operate wireless IP networks within their premises and public wireless hotspots have become common place throughout many towns and cities the coverage is patchy and far from complete.

Another problem that exists with internet telephone services is variations in the speed and condition of the network and/or internet connection used to connect the IP telephone. The speed of both wired and wireless networks and internet connections is vulnerable to both local and remote traffic fluctuations, and wireless networks are also susceptible to degradation due to transient environmental conditions.

In view of the above problems it is advantageous for IP telephone calls to be transferable from the IP medium, whether wired or wireless, to another communications medium, and preferably to be transferable back to the IP medium, whether wired or wireless, without disconnecting or losing the call.

Dual mode mobile devices are available that have both wireless IP radio and cellular radio modules so that users can connect to both wireless IP networks and cellular networks using a single device. This allows users to make telephone calls via the normal cellular network when outside the wireless coverage area of an IP network. There exist server-based methods to transfer calls between an IP network and a cellular network. However these involve the deployment of changes of software and/or hardware on mobile carriers. U.S. Pat. No. 6,327,470 describes a method of transferring a call between fixed and mobile networks for dual mode phones, but this method only works if the mobile carriers and fixed line operators allows call transfer to each other. The inventors are not aware of any existing client based method for transferring an existing call made on an IP network to a cellular network, if user moves outside the wireless coverage area of an IP network while on a call, and then for transferring the call back to the IP network when the wireless device is back within the wireless coverage area of the same or another IP network.

### SUMMARY OF THE INVENTION

Accordingly, it is an object of the current invention to provide a device, a method and/or a system for handoff of a VoIP internet telephone call from an IP network to a PLMN and for hand-back of the call to the IP network.

There is disclosed herein a device and a method for handoff of a VoIP internet telephone call from an IP network to a cellular network and for hand-back of the call to the IP network, in which during or after hand-off of the call an identifier of the hand-off call is obtained and stored and the identifier is used during hand-back of the call to the IP network.

More specifically, there is disclosed herein a mobile device having both internet telephone and cellular telephone operating modes for making either VoIP internet telephone calls or cellular telephone calls. The device has a handoff application for handing off a VoIP internet telephone call from the IP network to the cellular network. The handoff application detects a handoff condition for handoff of the call and in response thereto initiates a second VoIP call via the IP network to its own cellular subscription on the cellular network. When the second call is received by the mobile device, the handoff application determines that the second call is from the internet subscription of the mobile device and answers the second call. The handoff application then initiates transfer of the first VoIP call to the cellular network, and obtains from the VoIP telephone gateway a call leg identifier of the transferred call and stores the call leg identifier in the mobile device. If the handoff application then detects a hand-back condition for handoff of the transferred call from the cellular network back to an IP network it sends a request comprising the call leg identifier to initiate handoff of the transferred call back to the IP network.

Preferably, to obtain the call leg identifier, the handoff application subscribes the mobile device to a notification service of the telephone gateway such that the notification service sends the mobile telephone a message containing the call leg identifier of the transferred call. The subscription to the notification service can be made during or immediately after setup of the first call.

There is also disclosed herein a method of handing off a call on a dual mode mobile device from an IP network to a cellular network, comprising steps of:
1) detecting a handoff condition for handoff of a first call between a second device and an internet subscription of a mobile device to a cellular subscription of the mobile device,
2) initiating a second call to the cellular subscription of the mobile device through a telephone gateway,
3) initiating transfer of the first call to the cellular subscription,
4) obtaining from the telephone gateway a call leg identifier of the transferred call, and
5) storing the call leg identifier in the mobile device.

The method may also comprise subscribing the mobile device to a notification service of the telephone gateway such that the notification service sends the mobile telephone a message containing the call leg identifier of the transferred call.

There is also disclosed herein a method of handing back the call from the cellular network to the same or another IP network comprising steps of:
1) detecting a second handoff condition for handoff of the transferred call from the cellular subscription back to an internet subscription
2) retrieving the stored call leg identifier, and
3) sending a request comprising the call leg identifier to initiate handoff of the transferred call back to the internet subscription.

Further aspects of the invention will become apparent from the following description and the claims.

### BRIEF DESCRIPTION OF THE DRAWINGS

An exemplary form of the present invention will now be described by way of example only and with reference to the accompanying drawings, in which:

FIG. 1 illustrates an exemplary environment in which a wireless handoff scheme according to the invention is practiced,

FIG. 2 illustrates a dual mode wireless telephone handset,

FIG. 3 is a flow diagram of steps for handoff of a call from an IP network to a cellular network,

FIG. 4 is an example of call flow for handoff of a call from an IP network to a cellular network using Session Initiation Protocol (SIP),

FIGS. 5-8 schematically illustrate call connection routing before and after handoff for different call scenarios,

FIG. 9 is a flow diagram of steps for hand-back of the call from a cellular network to an IP network,

FIG. 10 is an example of call hand-back using SIP, and

FIG. 11 and 12 illustrate call routing before and after handoff in an environment having more than one PSTN gateway.

FIG. 13 illustrates an alternative exemplary environment in which a wired IP phone may handoff a call to a cellular network.

### DETAILED DESCRIPTION OF THE EXEMPLARY EMBODIMENTS

The invention will now be described as practiced in a dual mode wireless telephone handset for operating in both a wireless IP network and a public land mobile network (PLMN), commonly called a cellular network. The telephone has an internet telephone subscription for making voice over IP (VoIP) calls via the IP network and a cellular subscription for making cellular telephone calls via the PLMN. This is not however intended to limit the scope of use or functionality of the invention as those skilled in the art will recognize that a dual mode mobile device of the invention could take a different form such as a PDA, palm computer or laptop computer having two wireless modes for connecting to both wireless IP and cellular networks. Technology already exists for the connection of laptop computers and the like to PLMN networks for the provision of remote email for example.

The exemplary embodiment of the invention is described using session initiation protocol (SIP) and real time transport protocol (RTP) for VoIP telephone calls and uses functionality provided for in that standard. This is also not intended to limit the scope of use or functionality of the invention. Similar functionality is also available in VoIP protocol (H323) and other real time IP standards. It is envisaged that as the popularity of VoIP multi media communications increase other messaging and data transport protocols may become available in which the invention can be practiced. In the described exemplary embodiment functionality and procedures of SIP and cellular networks are discussed and used. It is understood that these are well-established public standards and full knowledge, functionality and use of the methods provided for within the standards is within the purview of those skill in the art.

FIG. 1 gives us schematic overview of the exemplary environment in which the invention is practiced. There is illustrated a dual mode mobile phone 100 that may connect to either an IP network 105 or a PLMN network 110. The PLMN 110 is anyone of the commonly use cellular networks worldwide and its type and operation are not important to the invention except that it has a plurality of base stations 140 that allow wireless connectivity of a subscriber for making telephone calls from a mobile phone as is common place. The IP network 105 is a public or private local area network (LAN) or a wide area network (WAN), and may be either private and/or part of a worldwide group of interconnected publicly accessible networks such as the internet. The IP network 105 has one or more wireless access points 11 5 for wireless connectivity with radio enabled wireless devices such as the dual mode phone 100. Also connected to the IP network is a VoIP server 125, in the illustrated case a SIP server, for providing an internet telephone service and a PSTN gateway 130 for providing a telephonic interconnection between the IP network 105 and a public switched telephone network (PSTN) 135. The SIP server 125 and PSTN gateway 130 might belong to a private group or organization or to an internet telephone service provider from which members of the public may obtain an internet telephone subscription, and may be located remotely from the wireless access points 115 as is commonly the case with internet based applications and services. The (PSTN) gateway allows VoIP internet telephone calls to be made between fixed and cellular telephones connected with the PSTN 135 and PLMN 110.

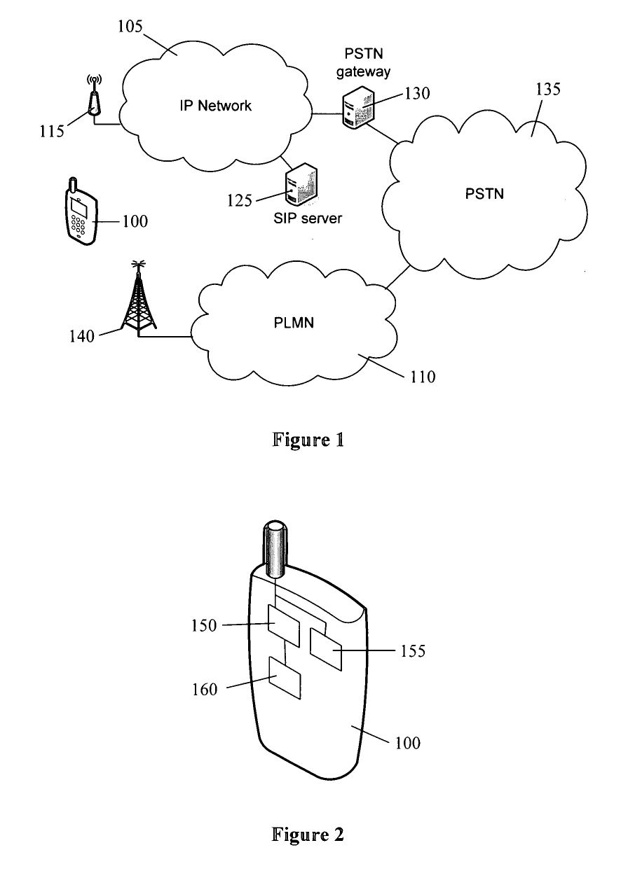

The dual mode mobile phone 100, schematically illustrated in FIG. 2, has an IP radio module 150 containing IP telephone service subscription information for wireless connection with the IP network 105 and a cellular radio module 155 containing cellular network subscription information for wireless connection with the PLMN 110. The user of the dual mode mobile phone 100 has subscriptions to both an internet telephone service and a cellular telephone service for making telephone calls via either the IP network 105 or the PLMN 110 as desired. Using either the IP network 105 or the PLMN 110 the user of the dual mode mobile phone 100 can make telephone calls to users of other internet telephone devices, to fixed line telephones or to other cellular telephone devices. In many cases the user of the mobile telephone 100 may choose to make his or her telephone calls via the IP network 105 for cost saving reasons. However, while PLMNs typically have extensive coverage in most urban, semi-urban and rural areas worldwide, the wireless coverage area of IP networks is less complete and somewhat patchy. Therefore, if the user of the dual mode telephone 100 has placed, or received, a telephone call via the IP network 105 and is on the move then there may frequently be a need for the dual mode telephone 100 to handoff the call to the cellular network 110 before the telephone 100 moves outside of the wireless coverage area of the IP network 105. If the mobile user then moves back within the wireless coverage area of the same or another accessible IP network they may desire, for cost or other reasons, for the call to be handed back to the IP network. A handoff application 160 is provided in the dual mode telephone 100 for coordinating handoff of a telephone call established on the IP network 105 to the cellular network 110, and if desired to hand-back the call to the IP network 105.

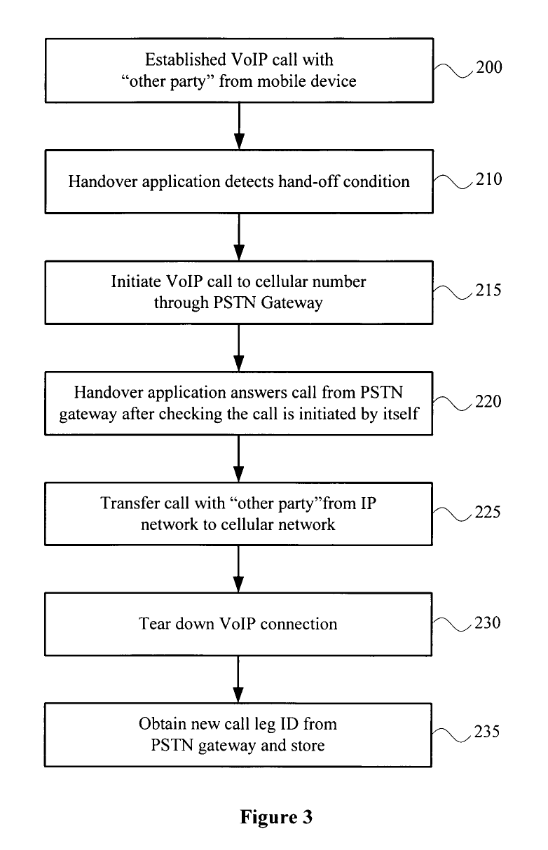

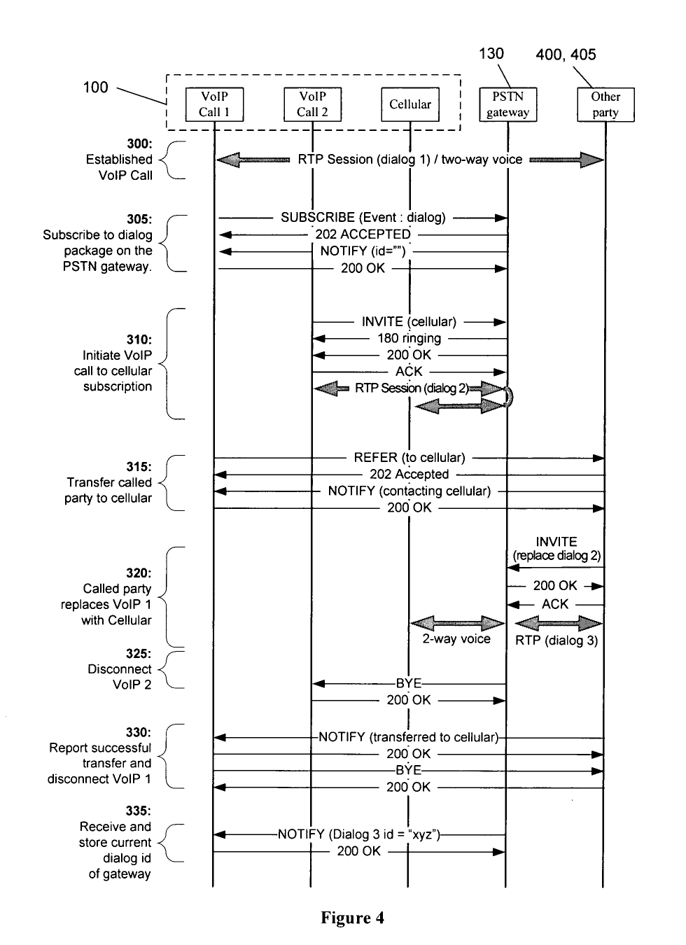

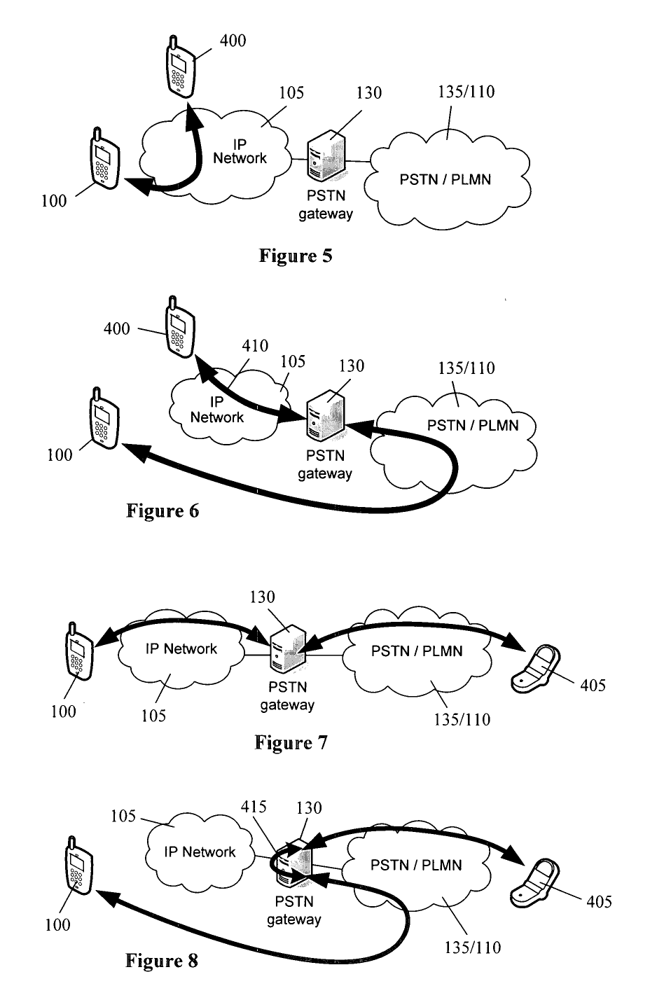

The steps in the procedures and example call flow in SIP for handoff of a call from an IP network to a cellular network are shown in FIG. 3 and 4 respectively. The handoff begins when the dual mode device 100 is on and established VoIP call via the IP network with another party (step 200). For the purpose of describing the present procedure it is not important whether the call was placed from or to the dual mode device or the other party is another internet telephone device or a fixed line or cellular telephone, however a discussion of this subject if given later with reference to FIGS. 5-8 and should be noted in relation to obtaining the correct call leg ID for hand-back of a transferred call from the cellular to IP networks. A handoff procedure is initiated when the handoff application detects a handoff condition (step 210). The handoff condition is not important to the invention and might be when the signal strength of the wireless IP network falls below a threshold value, for example −75 dBm and the dual mode telephone 100 is within the coverage area of a usable cellular network (PLMN) with which it has been allowed to register. Monitoring of the handoff condition may be by the handoff application 160 or by another application which flags or messages to the handoff application when the handoff condition is met. Upon detecting the handoff condition the handoff application 160 then initiates a second, simultaneous, VoIP call to the telephone number of dual mode telephone 100 cellular subscription (step 215). The call is received at the cellular subscription number of the dual mode telephone 100. The handoff application checks that the call received is the one that was initiated by itself by checking, for example, the caller ID, and is not an incoming call from another third party. If the call being received on the cellular subscription originates from the internet telephone subscription of the mobile telephone 100 then the handoff application answers the call in order to establish the cellular connection (step 220). Once the connection with the cellular subscription is established the handoff application transfers the call from the internet subscription to the cellular subscription (step 225). After successful completion of the transfer the original VoIP call is torn down (step 230). The transferred call is connected through the PSTN gateway. In order to permit successful hand back of the call to the IP network if the telephone 100 again enters an IP network the handoff application 160 must obtain from the PSTN gateway the call leg ID of the new call session between the PSTN gateway and the other party (step 235). The call leg ID is stored in memory of the dual mode telephone 100. In the exemplified embodiment the step of obtaining the call leg ID is shown as the last step, however this is not intended to limit the invention. The call leg ID can be obtained at any time after handoff (transfer) of the call to the cellular network but before the call is handed back to the IP network.

FIG. 4 schematically illustrates SIP messaging and call flow involved in the handoff of the call from the wireless IP network to the cellular network in the exemplified embodiment. In the illustrated call flow the SIP server is not shown for clarity. Nor is messaging or call flow on the PSTN/PLMN between the PSTN gateway and the cellular connection on the dual mode telephone 100. The skilled addressee will be able to fully appreciate the required messaging and call flow that occurs in the cellular network to establish the cellular call and as this is not important to the invention it is not shown here. The other party is shown for clarity. The other party may be either another IP phone operating in an IP network, a fixed line telephone phone connected to a PSTN or a cellular (mobile) telephone operating in a PLMN.

Referring to FIG. 4 at step 300 there is an existing VoIP call from the dual mode telephone 100 to the other party. Depending on the phone type of the other party the call will involve either an RTP session over the IP network 105, or an RTP session over the IP network 105 and two-way voice over the PSTN 135/PLMN 110. Either at the time of placing the existing call or at a suitable time before handoff occurs the handoff application subscribes the dual mode phone to a dialog event package on the PSTN gateway (step 305). Assuming that the PSTN gateway 130 is not involved in a current call session, because for example the existing call is an IP telephone to IP telephone call or the existing call is through another PSTN gateway as described later, the first NOTIFY message from the PSTN gateway to the dual mode telephone 100 returns a null call leg ID.

The handoff application then initiates the second VoIP call to its own cellular subscription using the INVITE method of the SIP protocol in the normal way (step 310). This establishes a second RTP session and two-way voice connection between the internet and cellular subscriptions of the dual mode telephone 100. The handoff application then initiates transfer of the call to the cellular connection by sending a REFER request to the other party (step 315). The other party replies with a notification that it is trying to contact the cellular subscription. The other party does this by sending an INVITE request with a replace header. If the INVITE is successful the other party is transferred to the cellular connection (step 320) and second VoIP connection is ended (step 325). The other party then notifies dual mode telephone 100 that the transfer was successful and the first VoIP call is also torn down (step 330).

As will be understood by the skilled addressee the event dialog subscription remains valid for a fixed time even after the VoIP calls are torn down and in accordance with the subscription the PSTN gateway 130 notifies the dual mode telephone 100 of the call leg ID for the call between the cellular connection and the other party (step 335). The call leg ID is stored in the dual mode telephone 100 for use in retrieving the call to affect hand- back if necessary.

This call leg ID is obtained by using the SUBSCRIBE/NOTIFY methods discussed below and is stored in the dual mode phone 100. FIGS. 5 to 8 illustrate call flow before and after handoff between the IP and PLMN networks for different calls scenarios. FIGS. 5 and 6 show before and after handoff call connections respectively when the other party is another IP telephone 400. Before handoff the call is routed through the IP network 105. After handoff the call is routed from other party 400 through the IP network 105, the PSTN gateway 130 and PSTN 135 to the cellular network 110 with which the dual mode telephone 100 is registered. The handoff application must obtain and store the call leg ID for session 410 between the PSTN gateway 130 and the other party 400 in FIG. 6.

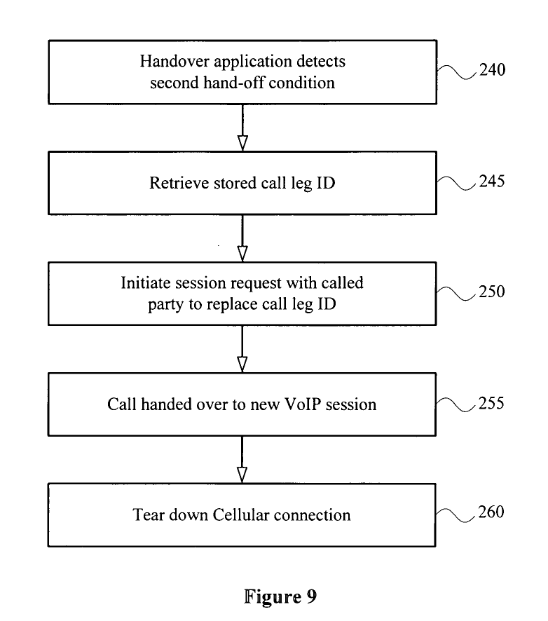

It has been mentioned previously that the other party may be another internet telephone device or a fixed line or cellular telephone. In the current exemplary embodiment, where a single PSTN gateway 130 is used, no actual VoIP call exists within the IP network after the call is handed-off to the cellular network in the case where the other party is a fixed telephone on the PSTN 135 or another cellular telephone. However, a call connection always exists within the PSTN gateway 130 to link the mobile device cellular call to the other party. This call connection is an internal call session of the PSTN gateway 130. In order to be able to initiate hand-back the call from the cellular network to the IP network the handoff application must have the call leg ID of this call session. FIGS. 7 and 8 show before and after handoff call connections respectively when the other party is a cellular telephone 405. Before handoff the call is routed through the IP network 105 the PSTN gateway 130 and PSTN 135 to the cellular network 110 with which the other phone 405 is registered. After handoff the call continues to be routed through the PSTN gateway 130 although both phones 100, 405 are registered on the cellular network I 10.

The scenario of FIGS. 7 and 8 also applies when other party is using a fixed line phone on the PSTN 135. Thus after handoff the call is always routed through the PSTN gateway 130 regardless of the location and connection of the telephones in use. The handoff application must obtain and store the call leg ID for session 415, in FIG. 8, linking the call within the PSTN gateway 130.

The call leg ID (or dialog ID) for a call session consists of a call-ID value, a local tag and a remote tag. There are two ways that the handoff application can obtain the call leg ID for the session, e.g. 410 or 415, between the PSTN gateway 130 and the other party in the transferred call. The first way is using Invite-Initiated Dialog Event Package in SIP RFC 4235. This is a client based solution that requires no modification of the PSTN gateway software or firmware. The second way is to install a proprietary event package software module in the PSTN gateway that is SIP RFC 3265 compliant. The following is a discussion of the two methods.

Using Invite-Initiated Dialog Event Package

In the exemplified embodiment the handoff application subscribes to a dialog event notification on the PSTN gateway 130 using the SIP SUBSCRIBE method with an event header specifying a dialog package. This enables the handoff application to obtain the call leg ID for the session between PSTN gateway 130 and the other party in the transferred call. By subscribing to a dialog package the subscriber is requesting notifications about particular dialogs that the server is in. The SUBSCRIBE messages requires an entity to be put in the request URL. This entity attribute contains a URL that identifies the user whose dialog information is reported in a NOTIFY body. In the present case, the entity is the cellular number of the dual mode mobile device 100. The NOTIFY will return the dialog state (call-leg state) of this entity once its dialog state is created, changed or terminated. The following is an example of use of the SUBSCRIBE method in the call flow of FIG. 4.

| | |
|---|---|
| Step 305: | |
| ==> | SUBSCRIBE sip:dualmode_cellular_number@pstn.gateway.com SIP/2.0 |
| | To: <sip:dualmode_cellular_number@pstn.gateway.com> |
| | From: <sip:dualmode_sip_userid@mobile.device.com>;tag=193492342 |
| | Call-ID: 898234234@pstn.gateway.com |
| | CSeq: 10 SUBSCRIBE |
| | Max-Forwards: 70 |
| | Contact: <sip:dualmode_sip_userid@mobile.device.com> |
| | Expires: 3600 |
| | Event: dialog |
| | Content-Length:0 |
| <== | 202 Accepted |
| <== | NOTIFY sip:dualmode_sip_userid@mobile.device.com SIP/2.0 |
| | To: <sip:dualmode_sip_userid@mobile.device.com>;tag=193492342 |
| | From: <sip:dualmode_cellular_number@pstn.gateway.com>;tag=4992881234 |
| | Call-ID: 898234234@pstn.gateway.com |
| | CSeq: 12 NOTIFY |
| | Max-Forwards: 70 |
| | Event: dialog |
| | Subscription-State: active;expires=3600 |
| | Contact: <sip:dualmode_cellular_number@pstn.gateway.com> |
| | Content-Type: application/dialog-info+xml |
| | Content-Length: 173 |
| | <?xml version=“1.0”?> |
| | <dialog-info xmlns=“urn:ietf:params:xml:ns:dialog-info” |
| | version=“0” state=“full” |
| | entity=“sip:dualmode_cellular_number@pstn.gateway.com”> |
| | </dialog-info> |
| ==> | 200 OK |
| Step 320: | |
| ==> | INVITE (replace Dialog 2) |
| <== | 200 OK |
| ==> | ACK |

The call is transferred in step 315 and in step 335 the PSTN gateway notifies the dual mode phone of the call leg ID for the new session dialog 3 between the PSTN gateway 130 and the other party.

| | |
|---|---|
| Step 335: | |
| <== | NOTIFY sip:dualmode_sip_userid@mobile.device.com SIP/2.0 |
| | To: <sip:dualmode_sip_userid@mobile.device.com>;tag=193492342 |
| | From: <sip:dualmode_cellular_number@pstn.gateway.com>;tag=4992881234 |
| | Call-ID: 898234234@pstn.gateway.com |
| | CSeq: 13 NOTIFY |
| | Max-Forwards: 70 |
| | Event: dialog |
| | Subscription-State: active;expires=3510 |
| | Contact: <sip:dualmode_cellular_number@pstn.gateway.com> |
| | Content-Type: application/dialog-info+xml |
| | Content-Length: 288 |
| | <?xml version=“1.0”?> |
| | <dialog-info xmlns=“urn:ietf:params:xml:ns:dialog-info” |
| | version=“0” state=“full” |
| | entity=“sip:dualmode_cellular_number@pstn.gateway.com”> |
| | <dialog id=“as007” call-id=“x” local-tag=“y” remote-tag=“z” |
| | direction=“initiator”> |
| | <state>confirmed</state> |
| | </dialog> |
| | </dialog-info> |
| ==> | 200 OK |

The call leg ID for the new session dialog 3 between the PSTN gateway 130 and the other party in this example is “xyz”

Using Proprietary Event Package Software Installed in PSTN

A second, and least preferred, method of obtaining the call leg ID from the PSTN gateway is to install a proprietary event package module in the PSTN gateway that is SIP RFC3265 compliant. This method has been tried and proven by the inventors to work but is least preferred because it is not a client-only solution. Nonetheless, it is described here because this method may be useful for private PSTN gateways within an organization. This solution uses the same subscribe and notify messages as the first solution but the target is the private or enterprise PSTN gateway with the proprietary event package software module. The following is an example of FIG. 4 step 305 and step 335 messaging for this solution.

| | |
|---|---|
| Step 305: | |
| ==> | SUBSCRIBE sip:dualmode_cellular_number@pstn.gateway.com SIP/2.0 |
| | To: <sip:dualmode_cellular_number@pstn.gateway.com> |
| | From: <sip:dualmode_sip_userid@mobile.device.com>;tag=193492342 |
| | Call-ID: 898234234@pstn.gateway.com |
| | CSeq: 10 SUBSCRIBE |
| | Max-Forwards: 70 |
| | Contact: <sip:dualmode_sip_userid@mobile.device.com> |
| | Expires: 3600 |
| | Event: proprietary_event_package;id=93809824 |
| | Content-Length:0 |
| <== | 202 Accepted |
| <== | NOTIFY sip:dualmode_sip_userid@mobile.device.com SIP/2.0 |
| | To: <sip:dualmode_sip_userid@mobile.device.com>;tag=193492342 |
| | From: <sip:dualmode_cellular_number@pstn.gateway.com>;tag=4992881234 |
| | Call-ID: 898234234@pstn.gateway.com |
| | CSeq: 12 NOTIFY |
| | Max-Forwards: 70 |
| | Event: proprietary_event_package |
| | Subscription-State: active;expires=3600 |
| | Contact: <sip:dualmode_cellular_number@pstn.gateway.com> |
| | Content-Type: application/proprietary_event |
| | Content-Length: 29 |
| | Roam_ID=1321;call_leg_ID=‘ ’ |
| ==> | 200 OK |
| Step 335: | |
| <== | NOTIFY sip:dualmode_sip_userid@mobile.device.com SIP/2.0 |
| | To: <sip:dualmode_sip_userid@mobile.device.com>;tag=193492342> |
| | From: <sip:dualmode_cellular_number@pstn.gateway.com>;tag=4992881234 |
| | Call-ID: 898234234@pstn.gateway.com |
| | CSeq: 13 NOTIFY |
| | Max-Forwards: 70 |
| | Event: proprietary_event_package |
| | Subscription-State: active;expires=3510 |
| | Contact: <sip:dualmode_cellular_number@pstn.gateway.com> |
| | Content-Type: application/proprietary_event |
| | Content-Length: 68 |
| | Roam_ID=1321;call_leg_ID=‘x%3Bfrom-tag%3Dy%3Bto-tag%D3z’ |
| ==> | 200 OK |

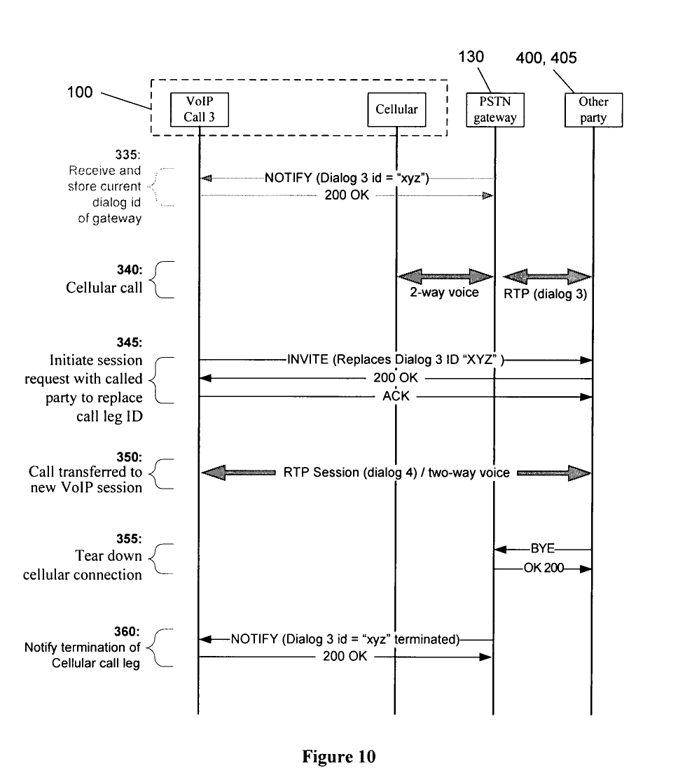

The steps in the hand-back procedures and example call flow in SIP are shown in FIGS. 9 and 10 respectively. Referring to FIG. 9, if the mobile device moves back within the wireless coverage area of the same or another accessible IP network a hand-back condition is created which is detected by the handoff application (step 240). Again, the hand-back condition may be monitored by the handoff application or by another module within the mobile telephone 100. The hand-back condition is also not important to the invention and might be when the signals strength of a wireless IP network with which the IP telephone can register exceeds a threshold value, for example −75 dBm. When the hand-back condition is met, the call can be handed-back to the wireless IP network. The handoff application retrieves the stored call leg ID for the call on the cellular network (step 245). The application then initiates a VoIP session via the IP network and by sending the retrieved call leg ID to the other party to initiate handover of the call to the new VoIP session (steps 250,255). Once the call is successfully handed over to the VoIP session the cellular session can be torn down (step 260).

FIG. 10 illustrates messaging and call flows involved in hand-back of the call from the cellular network to the wireless IP network in the exemplified embodiment. As shown in FIG. 10 the handoff application was notified of the call leg ID of the connection at the PSTN gateway. In the illustrated embodiment the call leg ID is “xyz”. This is stored in the mobile telephone 100. As step 340 the call is proceeding in a two-way voice/RTP session between the cellular connection and the other party. When the handoff application detects the second hand-off condition, i.e. the hand-back condition, it retrieves the stored call leg ID xyz and starts a third VoIP call to initiate a connection with the other party using the SIP INVITE method with a replace header. The replace header identifies the call leg ID xyz, which is replaced with a session dialog 4 between the VoIP call 3 from the mobile telephone 100 to the other party (step 350).

After reestablishing the call over the IP network between the mobile telephone 100 and the other party the cellular connection is torn down (step 355) and in accordance with the earlier subscriber requests the PSTN gateway issues a notification to the handoff application 160 that the call dialog 3 for the cellular connection was terminated.

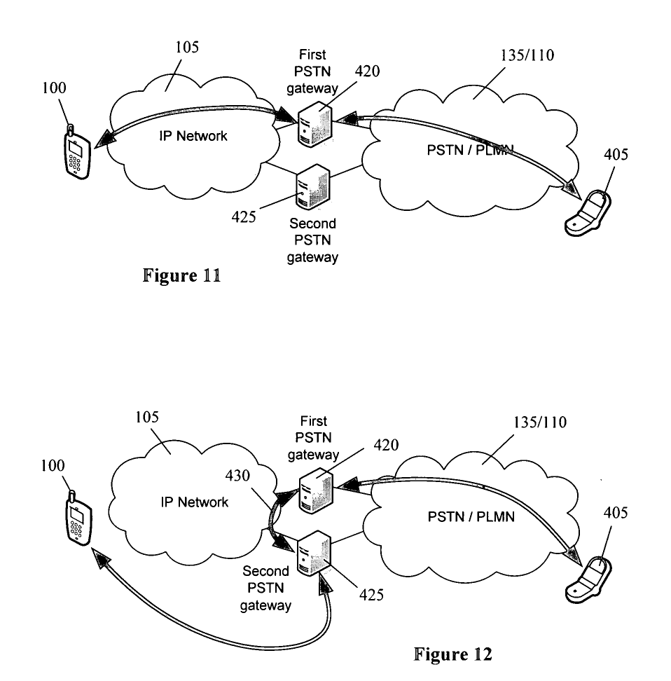

In the exemplary embodiment given above a single PSTN gateway 130 is used. However, this is not intended to limit the scope of use or functionality of the invention. Multiple PSTN gateways can be used. For example, and with reference to FIGS. 11 and 12, in an alterative embodiment an organization has a first PSTN gateway 420 for routing calls between its IP network 105 and the local PSTN 135. The organization also has a second PSTN gateway 425 dedicated to establishing and maintaining a cellular link with dual mode device 100 of the organization when the devices 100 roams from within the organizations IP network to the cellular network. Thus, an initial call placed or received on the IP network 105 to or from a fixed line or cellular telephone 405 outside the IP network is routed through the first PSTN gateway 420. When the dual mode telephone 100 begins to leave the wireless coverage area of the IP network 105 the handoff application 160 establishes a connection with the cellular subscription of its own dual mode telephone 100 using the second PSTN gateway 425. During transfer the call is linked between the first PSTN gateway 420 and the second PSTN gateway 425. The before and after connection schematics for this dual gateway scenario are depicted in FIGS. 11 and 12 respectively. In this scenario the handoff application must obtain and store the call leg ID of the session 430 between the two PSTN gateways. Upon retrieval of the call for hand-back to the IP network the call is reconnected through the first PSTN gateway 420 and the cellular connection through the second PSTN gateway 425 is torn down.

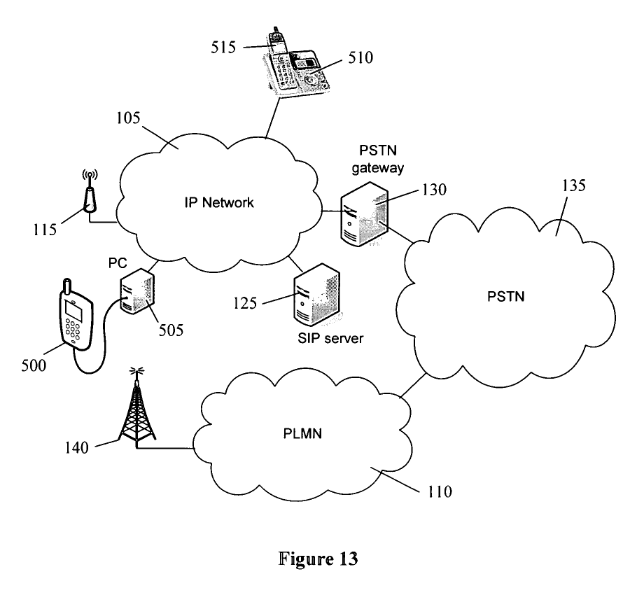

In the exemplary embodiments described above the IP telephone operates on a wireless IP network. However, the invention is equally applicable to IP telephones operating via a wired network or internet connection. FIG. 13 illustrates alternative embodiments in which one IP telephone 500 connects directly to a USB port or other port of a personal computer 505 (PC) and another IP telephone 510 has an Ethernet port for connection directly to an IP network 105. The telephones 500, 510 also have cellular network capabilities, and may optionally have other wireless radio capabilities. A user on an internet telephone call with one of the telephones on a wired network connection may wish to hand off the call from the IP network to the cellular because they wish to move to another location or because the quality of the network has degraded through increased traffic or the like. The user, through input means on the telephone, or in the case of telephone 500 via the computer 505, can manually issue an instruction to hand off the call to a cellular network. The call is handed off in the same way as described above. The manual instruction to hand off the call is the handoff condition in the above hand off procedure. If the user returns to the location of the wired network or network quality and speed increases again the user can reconnect the IP telephone to the wired network, if necessary, and issue a further instruction via input means on the telephone or through the computer to which the telephone is connected for the call to be handed back to the IP network. The input means for initiating the manual handover condition may be a dedicated button on the IP telephone or may be accessed through a certain menu screen on the telephone.

In one specific embodiment, the dual mode IP telephone 510 is a hands free speakerphone or conference phone directly connected to the network via an Ethernet connection. The hands free speakerphone also has a cordless handset 515 resting in a cradle of the telephone base unit. The cordless handset has both Digital Enhanced Cordless Telecommunications (DECT) and cellular wireless functions. A user can make an internet telephone call via the hands free speakerphone, which is connected via the hardwired network. If the user wants to move to another location they can pick up the cordless handset. Under normal conditions the cordless handset works in the normal manner of a DECT handset and the call remains connected via the speakerphone base unit. However, if the user has decided to move outside the range of the cordless handset the call can be handed off to a cellular network via push of a ‘hand off’ button.

It is envisaged that the invention may be used to hand off only a part of a data stream being received by an IP telephone to a cellular network connection. In yet another specific embodiment, the dual mode IP telephone has video conferencing functionality in which separate voice and video data streams are transmitted and received over the IP network. If there is degradation of the speed or quality of the IP network either one or both of the voice and image of a video call may become degraded. In any communication voice is more important and the user may choose to hand off the voice part of the video call to the cellular network in order to improve voice quality while keeping the video stream going over the IP network. If the IP network speed or quality increases again the user may choose to hand back the voice part of the call to the IP network.

The handoff criteria that triggers handoff and or hand back of a call between an IP network and cellular network is not important to the invention. The handoff condition could comprise one or more of various factors including, but not limited to, wireless signal strength, current and past transmission and/or reception data error rate, the wireless service provider, quality of service of IP connection, and user manual selection.

Several examples and exemplified embodiments of the invention have been described above. These are not intended to limit the scope of use of functionality of the invention. It should be appreciated that modifications and alternations obvious to those skilled in the art are not to be considered as beyond the scope of the present invention.

What is claimed is:

1. A mobile device having both internet telephone and cellular telephone operating modes, the device comprising a handoff application that detects a handoff condition for handoff of a first call between a second device and an internet subscription of the mobile device to a cellular subscription of the mobile device and in response thereto initiates a second call from the internet subscription to the cellular subscription of the mobile device through a telephone gateway, initiates transfer of the first call from the internet subscription to the cellular subscription, obtains from the telephone gateway a call leg identifier of the transferred call and stores the call leg identifier in the mobile device.

2. The mobile device of claim 1 wherein the handoff application further detects a second handoff condition for handoff of the transferred call from the cellular subscription back to an internet subscription and in response thereto sends a request comprising the call leg identifier to initiate handoff of the transferred call back to the internet subscription.

3. The mobile device of claim 1 wherein the handoff application subscribes the mobile device to a notification service of the telephone gateway such that the notification service sends the mobile telephone a message containing the call leg identifier of the transferred call.

4. The mobile device of claim 3 wherein the handoff application subscribes the mobile telephone to the notification service during or immediately after setup of the first call.

5. The mobile device of claim 1 wherein after initiates a second call from the internet subscription to the cellular subscription of the mobile device the handoff application detects the second call being received by the cellular subscription of the mobile device, determines that the second call is from the internet subscription of the mobile device and answers the second call.

6. The mobile device of claim 1 wherein the handoff application initiates transfer of the first call from the internet subscription to the cellular subscription by initiating connection of the other device with the cellular subscription and terminating the first and second calls on the internet subscription.

7. The mobile device of claim 1 wherein the handoff application communicates with the telephone gateway and/or the second telephone using Session Initiation Protocol.

8. The mobile device of claim 1 wherein the handoff application detects the handoff and second handoff conditions by monitoring signal strength of a wireless IP network.

9. The mobile device of claim 1 wherein the internet telephone operating mode is via a wired internet connection.

10. A method of handing off a call on a dual band mobile device between an IP network and a cellular network, the method comprising:
detecting a handoff condition for handoff of a first call between a second device and an internet subscription of a mobile device to a cellular subscription of the mobile device,
initiating a second call to the cellular subscription of the mobile device through a telephone gateway,
initiating transfer of the first call to the cellular subscription,
obtaining from the telephone gateway a call leg identifier of the transferred call,
storing the call leg identifier in the mobile device.

11. The method of claim 10 further comprising:
detecting a second handoff condition for handoff of the transferred call from the cellular subscription back to an internet subscription
retrieving the stored call leg identifier, and
sending a request comprising the call leg identifier to initiate handoff of the transferred call back to the internet subscription.

12. The method of claim 10 further comprising subscribing the mobile device to a notification service of the telephone gateway such that the notification service sends the mobile telephone a message containing the call leg identifier of the transferred call.

13. The method of claim 10 wherein subscribing the mobile device to the notification service of the telephone gateway is done during or immediately after setup of the first call.

14. The method of claim 10 wherein after initiating a second call from the internet subscription to the cellular subscription of the mobile device the handoff application detects the second call being received by the cellular subscription of the mobile device, determines that the second call is from the internet subscription of the mobile device and answers the second call.

15. The method of claim 10 wherein the handoff application initiates transfer of the first call from the internet subscription to the cellular subscription by initiating connection of the second device with the cellular subscription and terminating the first and second calls on the internet subscription.

16. The method of claim 10 wherein the handoff application communicates with the telephone gateway and/or the second telephone using Session Initiation Protocol.

17. The method of claim 10 wherein the handoff application detects the handoff and second handoff conditions by monitoring signal strength of a wireless IP network.

18. A telephone system for handoff of an internet telephone call to a cellular network and which permits hand back of the call from the cellular network, the system comprising:
a telephone gateway having a subscription service for reporting a call leg identifier of a call handled by the gateway, and
a handoff application for storage and operation on a mobile device having both internet telephone and cellular telephone operating modes, the handoff application, when operated on said mobile device, detects a handoff condition for handoff of a first call between a second device and an internet subscription of the mobile device to a cellular subscription of the mobile device and in response thereto initiates a second call from the internet subscription to the cellular subscription of the mobile device through a telephone gateway, initiates transfer of the first call from the internet subscription to the cellular subscription, obtains from the telephone gateway a call leg identifier of the transferred call and stores the call leg identifier in the mobile device.

19. The telephone system of claim 18 wherein the handoff application further detects a second handoff condition for handoff of the transferred call from the cellular subscription back to an internet subscription and in response thereto sends a request comprising the call leg identifier to initiate handoff of the transferred call back to the internet subscription.

20. The telephone system of claim 18 wherein the handoff application subscribes the mobile device to the subscription service of the telephone gateway such that the subscription service sends the mobile telephone a message containing the call leg identifier of the transferred call.

21. The telephone system of claim 20 wherein the handoff application subscribes the mobile telephone to the subscription service during or immediately after setup of the first call.

22. The telephone system of claim 18 wherein after the handoff application initiates a second call from the internet subscription to the cellular subscription of the mobile device the handoff application detects the second call being received by the cellular subscription of the mobile device, determines that the second call is from the internet subscription of the mobile device and answers the second call.

23. The telephone system of claim 18 wherein the handoff application initiates transfer of the first call from the internet subscription to the cellular subscription by initiating connection of the other device with the cellular subscription and terminating the first and second calls on the internet subscription.

24. The telephone system of claim 18 wherein the handoff application communicates with the telephone gateway and/or the second telephone using Session Initiation Protocol.

25. The telephone system of claim 18 wherein the handoff application detects the handoff and second handoff conditions by monitoring signal strength of a wireless IP network.

26. A mobile device having both internet telephone and cellular telephone operating modes, the device comprising a handoff application which in use during or after hand-off of a telephone call from an IP network to a cellular network obtains and stores an identifier of the hand-off call for uses during future hand-back of the call to an IP network.
